(19) United States
(12) Patent Application Publication
(10) Pub. No.: US 2010/0318301 A1
(43) Pub. Date: Dec. 16, 2010

(54) METHOD AND SYSTEM FOR ASSESSING IMMUNE SYSTEM RESPONSE

(76) Inventor: Benjamin J. Zeskind, Boston, MA (US)

Correspondence Address: WOLF GREENFIELD & SACKS, P.C., 600 ATLANTIC AVENUE, BOSTON, MA, 02210-2206, US

(21) Appl. No.: 12/835,962

(22) Filed: Jul. 14, 2010

Related U.S. Application Data
(63) Continuation of application No. PCT/US2009/000305, filed on Jan. 16, 2009.
(60) Provisional application No. 61/021,434, filed on Jan. 16, 2008.

(51) Int. Cl. G06F 19/00

(52) U.S. Cl. 702/19

(57) ABSTRACT

A method and system for determining the extent to which a patient will respond to a therapeutic regimen by assessing how that regimen will impact the functioning of a patient's immune system. An extent to which a patient will respond to a therapeutic regimen may be assessed based on a set of values for measurable parameters that relate to one or more characteristics of the patient's immune system, and receptor-ligand binding and trafficking characteristics of the patient's immune system, as well as other optional parameters and characteristics of the immune system. A mathematical model of the immune system is provided and may be implemented to predict immune system response, as well as identify parameters that have a greatest impact on predicting immune system response.

### RELATED APPLICATIONS

This application is a continuation of PCT/US2009/000305 filed on Jan. 16, 2009, and claims the benefit of U.S. provisional application Ser. No. 61/021,434, filed on Jan. 16, 2008, the entire disclosures of both of which are incorporated herein by reference.

### BACKGROUND

Fewer than 25% of patients respond to a typical cancer therapy, and there is usually no way to identify likely responders before treatment is administered. Many therapeutic regimens that are lifesaving for particular subpopulations of patients fail to gain government approval due to low response rates in the general population. This deprives patients of lifesaving therapies and causes significant financial losses for pharmaceutical and biotechnology companies. Oncologists are forced to use trial-and-error to select among the few approved therapies. During the months required to assess response to a therapy, patients may die or be so severely weakened that another therapy cannot be attempted. As a result, health plans waste tens of thousands of dollars per patient on ineffective treatments.

For instance, Interleukin-2 (IL-2) is a cytokine therapy approved for use in late stage (i.e., metastatic) kidney cancer and melanoma. IL-2 is the only therapy that can cause a complete and durable response, in other words a cure, but it only produces this response in 7% of patients. High-dose IL-2 treatment is so toxic that patients must be hospitalized in intensive care, costing payers $60,000 per cycle of therapy. This toxicity and the low response rate leads some patients to forgo IL-2 therapy, opting instead for therapies that are less toxic but that cannot provide a complete response. There is a long-felt but unmet need among oncologists for a test to identify non-responders and spare these patients from needless suffering, while payers want to avoid the cost of administering IL-2 to non-responders.

As another example, anti-CTLA4 therapies have been developed for late stage melanoma and shown to produce durable complete responses in 8% of patients. However, there is currently no effective means for identifying those likely responders. As a result clinical trials in the general melanoma population have produced relatively minor improvements in median survival time, leading the manufacturer to cancel a Phase III tremelimumab trial at great financial loss.

In contrast, trastuzumab (Herceptin) is a breast cancer drug that has received FDA approval and produces over $1 billion in revenue for it's manufacturer. Trastuzumab has only a 9% response rate among all breast cancer patients, but a test exists (the Her2/neu test) which can identify a subpopulation of ˜30% of patients who have an approximately 30% likelihood of response.

The contrast between trastuzumab and tremelimumab demonstrates that virtually any information that can help to identify subpopulations that differ in their likelihood of response can create significant value for pharmaceutical and biotech companies, patients, oncologists, and health plans.

### SUMMARY OF INVENTION

One aspect of the invention provides a method for determining the extent to which a patient will respond to a therapeutic regimen by assessing how that regimen will impact the functioning of a patient's immune system. Current approaches to identifying likely responders typically involve statistical correlation. For instance, the expression levels of thousands of genes are assessed to determine patterns of gene expression that correlate with response. In one embodiment, the invention provides for an entirely different approach in which an assessment is made of how the therapy will affect the immune systems of particular patients.

In one aspect of the invention, a method for determining an extent to which a patient will respond to a therapeutic regimen includes providing a set of values for measurable parameters that relate to one or more characteristics of the patient's immune system, and assessing how a therapeutic regimen will impact functioning of the patient's immune system based on the set of values and receptor-ligand binding and trafficking characteristics of the patient's immune system. Thus, for example, aspects of the invention may be used to determine whether a cancer patient's immune system will favorably respond to a particular treatment even before the treatment is administered, e.g., an assessment can be made whether the patient's immune system will develop a cytotoxic response (or other response) to tumor cells as a result of the therapeutic regimen. The assessment may be made based on measurable parameters of the patient's immune system, such as a number of diseased cells, a number of receptors of a particular type on each cell of a selected class, a binding affinity for the receptors, and others. The receptor-ligand binding and trafficking characteristics may be represented in a mathematical model that is developed for one or more specific therapeutic regimens and that uses the measurable parameters as inputs. The model may be used to assess how the immune system will respond to the therapeutic regimen given the initial state of the measurable parameters, thus indicating whether the therapeutic regimen will be effective or not.

In another aspect of the invention, a system for determining an extent to which a patient will respond to a therapeutic regimen includes a parameter input that receives a set of values for measurable parameters that relate to one or more characteristics of the patient's immune system, and an immune system response assessment module that assesses how a therapeutic regimen will impact functioning of the patient's immune system based on the set of values and receptor-ligand binding and trafficking characteristics of the patient's immune system. The parameter input may receive values for measurable parameters in any suitable way, such as by keyboard input by a user, by random generation, from the immune system response assessment module (e.g., when the module is performing an iterative process in which one or more measurable parameters are adjusted to assess immune system response to different parameter values), by performing an assay or other analysis on patient blood or other samples, and so on. The assessment module may include a mathematical model that is implemented on a computer. The model may represent functions of the immune system, including receptor-ligand binding and trafficking characteristics and other portions of the immune system, and may be specially constructed for a particular patient, or may be created for a class of patients or more general group. By “solving” the model for a given set of measurable parameters, the assessment module may generate an output that indicates the effectiveness of one or more therapeutic regimens. Moreover, different models may be created for different therapeutic regimens, as needed, so that the effect of different therapies may be evaluated. Of course, different therapeutic regimens may be represented by different values for measurable parameters. For example, if it is known that a particular therapy adjusts binding affinity for a receptor to a particular level or range of values, that value or value range may be provided as an input to the assessment module.

One aspect of the invention provides a method for identifying measurable characteristics that can distinguish subpopulations of patients who differ in the extent of their response to a therapeutic regimen. During the development of a therapy (such as a small molecule, an antibody, a protein, a cytokine, a vaccine, a cell-based therapy, etc.) it is common to look for “biomarkers”—measurable characteristics that can provide information about a patient's likelihood of response. Such biomarkers are typically identified using high-throughput statistical methods focused on correlation as described above, or else are intrinsic to the design of the therapy itself—such as the Her2/neu test for identifying patients whose tumors overexpress the Her2 receptor and are therefore likely responders to trastuzumab—an antibody designed to bind to Her2 receptors. In one embodiment, the invention provides for a different approach to identifying biomarkers by determining the extent to which a given therapy will have different affects on the immune systems of different patients. For many therapies, the impact of the therapy on the immune system is causally linked to a patient's response. For instance, most monoclonal antibody-based therapies function through a process called antibody-dependent cellular cytotoxicity (ADCC) in which the antibodies bind to malignant cells and then provide an activating signal to natural killer (NK) cells. So differences in the extent to which different patients will develop an ADCC response to an antibody therapy cause differences in response.

One aspect of the invention specifically evaluates the impact of a therapy on the cytotoxic response of a patient's immune system. In the case of cancer, the immune system improperly fails to develop a cytotoxic response to malignant cells, while in the case of autoimmune disease the immune system improperly develops a cytotoxic response to healthy cells. Since many successful therapies restore the proper functioning of the immune system's cytotoxic response, one embodiment of the invention involves specifically evaluating how a therapy affects the cytotoxic response in particular patients in order to identify likely responders or identifying measurable characteristics that can in turn be used to identify likely responders.

One aspect of the invention involves an analysis of the number of receptor-ligand complexes present on the surface of cytotoxic immune cells. Receptor-ligand surface complexes generate signals that cytotoxic immune cells utilize to determine whether or not to generate a cytoxic response to a particular target cell. In one embodiment, the analysis includes determining the number of complexes by direct measurement or calculation. In another embodiment, the analysis involves another measurement that is proportional to or correlated with the number of complexes. In another embodiment, the number of receptor-ligand complexes is analyzed during or after the administration of a therapeutic regimen in order to assess whether or not a cytotoxic reaction is occurring. In another embodiment, prior to the administration of a therapy the number of receptor-ligand surface receptors is analyzed and/or an assessment is made of how the administration of a therapy will influence the number of receptor-ligand surface complexes present on a cytotoxic immune system cell.

One aspect of the invention involves an analysis of parameters and other factors that influence or provide information about the number of receptor-ligand complexes present on the surface of cytotoxic immune system cells. It may not always be necessary or efficient to determine the actual number of receptor-ligand surface complexes on a cytotoxic immune system cell. Instead, in certain patients there may be one or more particular parameters or factors that have a strong effect on the number of complexes present. For instance, high binding affinity on a particular receptor could strongly influence the number of complexes. However, there are a number of similar factors and not all of them have a significant effect in all patients. In one embodiment of the invention, the analysis involves assessing one or more of these parameters. In another embodiment of the invention, the relative effect of each parameter on the number of receptor-ligand surface complexes is compared in order to determine a subset of parameters/factors that can be measured to provide sufficient information about the number of complexes without the need to measure and quantify every parameter.

One aspect of the invention involves the use of a computational system (e.g., a mathematical model implemented on a computer) to determine the number of receptor-ligand complexes present on the surface of a particular type of cytotoxic immune cell or to quantify the extent to which one or more factors influences the number of complexes present. Determining the number of receptor-ligand surface complexes may not be possible from a direct measurement, but there may be a way to calculate the number by a computational analysis of parameters that can be directly measured. Similarly, due to the presence of feedback loops and other complexities, it may only be possible after a computational analysis to determine which factors influence the number of complexes present on a particular type of cytotoxic immune cell in patients with particular immunological characteristics. In one embodiment, the computational system allows simulation to determine in advance how the use of a particular therapy will impact the number of complexes, and how various patient characteristics influence how the additional of a particular therapy will influence the number of complexes.

One aspect of the invention involves using a computational system that models receptor-ligand binding and trafficking. The dynamics of receptor-ligand binding and trafficking play a significant role in determining the number of receptor-ligand complexes on the surface of cytotoxic immune system cells. In turn, the number of complexes plays a significant role in determining whether or not a cytotoxic response occurs. A computational system can accurately model the dynamics of receptor-ligand binding and trafficking. In one embodiment, the receptor-ligand binding and trafficking dynamics are modeled for a single type of receptor on cytotoxic immune cells (i.e., the IL-2 receptor).

One aspect of the invention specifically extends the computational model to include more than one type of receptor. (A receptor may vary by “type” in this context by both the compound(s) that the receptor binds to as well as the type of cell the receptor is located on, e.g., two receptors for the same compound may be of a different “type” because they are present on different types of immune system cells.) This may be crucial in some embodiments to capture the balance between signaling from activating and inhibitory receptors that determines whether or not cytotoxic immune cells develop a cytotoxic reaction. In one specific embodiment, the receptor-ligand binding and trafficking dynamics are modeled for two or more types of receptors on NK cells (i.e., the IL-2 receptor and the TGFβ receptor).

One aspect of the invention involves extending the model of receptor-ligand binding and trafficking to cells that are NOT cytotoxic immune system cells, but that compete with cytotoxic immune cells for particular ligands. The number of receptor-ligand surface complexes on a cytotoxic immune cell depends significantly on the quantity of ligand available. Other cell types besides cytotoxic immune cells can influence the quantity of ligand available and thus influence the development of a cytotoxic reaction. Receptor-ligand binding and trafficking dynamics are equally important for these other cell types, and so a model of receptor-ligand binding on these other cell types can provide vital information for analyzing cytotoxicity.

One aspect of the invention involves modeling the dynamics or one or more receptor types on regulatory T cells (CD4+CD25+foxp3 Tregs) in addition to natural killer (NK) cells or cytotoxic T lymphocytes. In one specific embodiment, the model includes the IL-2 receptor and is able to capture the “competition” between Tregs and NK cells for a limited supply of a ligand which in this case is IL-2. Tregs deplete the concentration of IL-2 and reduce the amount available for NK cells. In another embodiment, the dynamics of the TGFβ receptor are modeled for malignant cells in addition to NK cells. In this embodiment, the model is able to capture the fact that as tumors reduce their expression of TGBβ receptors, more is available to bind to NK cells and inhibit the NK cells from developing a cytotoxic response.

In one aspect of the invention, receptor-ligand binding and trafficking dynamics are defined to include a number of specific processes. In one specific implementation, the equations and processes included in a model include: direct binding of ligand to receptor, internalization of receptor-ligand complexes into endosomes, dissociation of ligand-receptor complexes, induced receptor synthesis in response to binding, constitutive internalization of unbound receptors, constitutive biosynthesis of new receptors, binding of ligand to receptor in endosomes, dissociation of ligand-receptor complexes in endosomes, lysosomal degradation of receptor-ligand complexes in endosomes, lysosomal degradation of unbound receptors in endosomes, recycling of free ligand in endosomes, and sorting of bound ligand to degradation. In one aspect of the invention, a mathematical model that includes the dynamics of receptor-ligand binding and trafficking may be further refined to include induced ligand synthesis in response to binding. This addition may be necessary to capture positive feedback loops that can occur when receptor-ligand complexes induce cells to generate additional ligand.

These and other aspects of the invention are described below in the following detailed description and claims.

### BRIEF DESCRIPTION OF THE DRAWINGS

Aspects of the invention are described below with reference to illustrative embodiments and to the following drawings in which like numerals reference like elements, and wherein:

FIG. 1 is a schematic block diagram of a therapeutic regimen assessment system in an illustrative embodiment.

### DETAILED DESCRIPTION

Aspects of the invention are described below with reference to illustrative embodiments. However, aspects of the invention are not limited to the embodiments described.

As described above, aspects of the invention provide techniques for assessing the likely response of a patient's immune system to one or more therapeutic regimens. As used herein, a therapeutic regimen may involve a treatment that is performed one or more times for a patient, and the treatment may involve the use of one or more drugs or compounds, the use of electromagnetic or other radiation, the use of physical touch or other manipulation or alteration of patient body portions (such as surgery to implant a tissue or device, or to remove tissue or a device), and so on. In short, a therapeutic regimen may include any suitable technique or procedure used to treat a disease or other patient condition.

The assessment of the immune system response may be performed based on a set of values for measurable parameters that relate to one or more characteristics of the patient's immune system. (As used herein, a set of values for measurable parameters may include one or more parameters.) Such measurable parameters may include features such as a number of immune cells of a specific type, a number of diseased cells, a number of receptors per cell for a specific type of receptor on a specific type of cell, a binding affinity of receptors, a number of ligands per diseased cell, a concentration of soluble ligands in solution, a number of therapeutic antibodies per diseased cell, and others discussed more fully below. The parameters used to assess the likely patient immune system response may be provided in any suitable way, such as by actually measuring the one or more parameters for the patient (e.g., using blood or other samples from the patient), by selecting values, or value ranges, from suitable literature, research or other sources, by estimation, by random generation (such as by a computer generating random parameter values), by an expert system, neural network or other trainable system, and others. Thus, a set of values for parameters used in immune system assessment may be provided in any one of a variety of suitable ways.

Assessment of the impact of a therapeutic regimen may be done based not only on the set of values for the measurable parameters, but also a model of at least a portion of the patient's immune system. In one embodiment, the model must take into account receptor-ligand binding and trafficking characteristics of the patient's immune system. The model may take any suitable form, such as a mathematical model including one or more differential equations that uses one or more inputs (e.g., including one or more of the values in the set of values for measurable parameters) and are solved using a suitably programmed computer. In another embodiment, the model may be implemented in a relatively simple form, such as one or more threshold values that are used to determine whether one or more of the values in the set of values for measurable parameters are above or below a corresponding threshold. Depending on the result, an assessment may be made that a related therapeutic regimen is likely to produce a desired immune system response. For example, one model may be used to determine of a number of receptors per cell for a specific type of receptor on a specific type of cell is above or below a corresponding threshold. Based on this determination (and possibly others), an assessment may be made regarding how a particular therapeutic regimen will impact functioning of the patient's immune system. Threshold values or other portions of the model may be determined using an empirical approach, e.g., by determining values for a set of measurable parameters, administering a therapeutic regimen, observing the immune system response, and determining the portion of the model based on the parameters and immune system response.

In one specific embodiment, a mathematical model that incorporates receptor-ligand binding and trafficking characteristics of the patient's immune system may include the following equations or their equivalents:

Processes of the receptor-ligand binding and trafficking characteristics that are modeled may include the direct binding of ligand (L) to surface receptors (R_{S}) to form surface complexes (C_{S}) which occurs with an association rate constant (k_{f}), as represented by:

$$\frac{d {C}_{S}^{n , m}}{d t} = {k}_{f}^{n , m} \cdot {L}^{n} [ t ] \cdot {R}_{S}^{n , m} [ t ]$$

A second process that may directly affect the number of surface complexes is the internalization of those complexes, which occurs with an internalization rate constant (kₑ), as represented by:

$$\frac{d {C}_{S}^{n , m}}{d t} = - {k}_{e}^{n , m} \cdot {C}_{S}^{n , m} [ t ]$$

A third process that may directly affect the number of surface complexes is the dissociation of those complexes, which occurs with dissociation rate constant of (kᵣ), as represented by:

$$\frac{d {C}_{S}^{n , m}}{d t} = - {k}_{r}^{n , m} \cdot {C}_{S}^{n , m} [ t ]$$

Summing these three processes yields:

$$\frac{d {C}_{S}^{n , m}}{d t} = {k}_{f}^{n , m} \cdot {L}^{n} [ t ] \cdot {R}_{S}^{n , m} [ t ] - {k}_{r}^{n , m} \cdot {C}_{S}^{n , m} [ t ] - {k}_{e}^{n , m} \cdot {C}_{S}^{n , m} [ t ] \qquad$$

The number of surface receptors may also affected by the direct binding of ligand (L) to surface receptors (R_{S}) to form surface complexes (C_{S}) which occurs with an association rate constant (kᵣ), as represented by:

$$\frac{d {R}_{S}^{n , m}}{d t} = - {k}_{f}^{n , m} \cdot {L}^{n} [ t ] \cdot {R}_{S}^{n , m} [ t ]$$

The number of surface receptors may also be influenced by the induced receptor synthesis rate (k_{syn}), which describes the extra receptors synthesized in response to binding, as represented by:

$$\frac{d {R}_{S}^{n , m}}{d t} = {k}_{syn}^{n , m} \cdot {C}_{S}^{n , m} [ t ]$$

Additionally, the number of surface receptors may increase with the dissociation of receptor-ligand complexes which occurs with dissociation rate constant of (kᵣ), as represented by:

$$\frac{d {R}_{S}^{n , m}}{d t} = {k}_{r}^{n , m} \cdot {C}_{S}^{n , m} [ t ]$$

The number of surface receptors may be decreased by constitutive internalization of unbound receptors, the rate constant of which is kₜ, as represented by:

$$\frac{d {R}_{S}^{n , m}}{d t} = - {k}_{t}^{n , m} \cdot {R}_{S}^{n , m} [ t ]$$

Finally, the number of surface receptors may be increased by constitutive biosynthesis, which occurs at a rate of V_{S}, as represented by:

$$\frac{d {R}_{S}^{n , m}}{d t} = {V}_{S}^{n , m}$$

Summing these processes yields:

$$\begin{matrix}\frac{d {R}_{S}^{n , m}}{d t} = \\ - {k}_{f}^{n , m} \cdot {L}^{n} [ t ] \cdot {R}_{S}^{n , m} [ t ] + {k}_{syn}^{n , m} \cdot {C}_{S}^{n , m} [ t ] + {k}_{r}^{n , m} \cdot {C}_{S}^{n , m} [ t ] - {k}_{t}^{n , m} \cdot {R}_{S}^{n , m} [ t ] + {V}_{S}^{n , m}\end{matrix}$$

The number of receptor-ligand complexes internalized into endosomes may be affected by the internalization rate constant (kₑ), as represented by:

$$\frac{d {C}_{i}^{n , m}}{d t} = {k}_{e}^{n , m} \cdot {C}_{S}^{n , m} [ t ]$$

The number of complexes internalized in endosomes may be further increased by the binding of free ligand and receptor in endosomes, which occurs with an association rate of (k_{fe}), and decreased by the dissociation of complexes which occurs with a dissociation rate of (kᵣₑ), as represented by:

$$\frac{d {C}_{i}^{n , m}}{d t} = {k}_{fe}^{n , m} \cdot {L}_{i}^{n , m} [ t ] \cdot {R}_{i}^{n , m} [ t ]$$

Finally, the number of complexes internalized in endomsomes may be decreased by lysosomal degradation of receptor-ligand complexes, which occurs with a degradation rate constant (kₕ), as represented by:

$$\frac{d {C}_{i}^{n , m}}{d t} = - {k}_{h}^{n , m} \cdot {C}_{i}^{n , m} [ t ]$$

Summing together yields:

$$\begin{matrix}\frac{d {C}_{i}^{n , m}}{d t} = {k}_{e}^{n , m} \cdot {C}_{S}^{n , m} [ t ] + {k}_{fe}^{n , m} \cdot {L}_{i}^{n , m} [ t ] \cdot {R}_{i}^{n , m} [ t ] - \\ {k}_{re}^{n , m} \cdot {C}_{i}^{n , m} [ t ] - {k}_{h}^{n , m} \cdot {C}_{i}^{n , m} [ t ]\end{matrix}$$

The number of unbound receptors internalized into endosomes may be increased by the constitutive internalization of receptors, which occurs with a rate constant of (kₜ), as represented by:

$$\frac{d {R}_{i}^{n , m}}{d t} = {k}_{t}^{n , m} \cdot {R}_{S}^{n , m} [ t ]$$

The number of unbound receptors internalized in endomsomes may also be increased by dissociation of receptor-ligand complexes in endosomes, which occurs with a dissociation rate constant (kᵣₑ), and decreased by the association of free ligand and receptor in endosomes, which occurs with the association rate constant (k_{fe}), as represented by:

$$\frac{d {R}_{i}^{n , m}}{d t} = - {k}_{fe}^{n , m} \cdot {L}_{i}^{n , m} [ t ] \cdot {R}_{i}^{n , m} [ t ]$$

$$\frac{d {R}_{i}^{n}}{d t} = {k}_{re}^{n} \cdot {C}_{i}^{n} [ t ]$$

Finally, the number of unbound receptors in endosomes may also be decreased by lysosomal degradation, which occurs with a rate constant (kₕ), as represented by:

$$\frac{d {R}_{i}^{n , m}}{d t} = - {k}_{h}^{n , m} \cdot {R}_{i}^{n , m} [ t ]$$

Summing together,

$$\begin{matrix}\frac{d {R}_{i}^{n , m}}{d t} = {k}_{t}^{n , m} \cdot {R}_{S}^{n , m} [ t ] - {k}_{fe}^{n , m} \cdot {L}_{i}^{n , m} [ t ] \cdot {R}_{i}^{n , m} [ t ] + \\ {k}_{re}^{n , m} \cdot {C}_{i}^{n , m} [ t ] - {k}_{h}^{n , m} \cdot {R}_{i}^{n , m} [ t ]\end{matrix}$$

The amount of free ligand present in endosomes may be decreased by the association of free ligand and receptor in endosomes, which occurs with the association rate constant (k_{fe}), and increased by dissociation of receptor-ligand complexes in endosomes, which occurs with a dissociation rate constant (kᵣₑ). Because these processes are occurring only within the endosome, they are divided by the endosomal volume (Vₑ) and Avogadro's number (N_{A}), as represented by:

$$\frac{d {L}_{i}^{n , m}}{d t} = \frac{- {k}_{fe}^{n , m} \cdot {L}_{i}^{n , m} [ t ] \cdot {R}_{i}^{n , m} [ t ]}{{V}_{e} \cdot {N}_{A}} \qquad \frac{d {L}_{i}^{n , m}}{d t} = \frac{{k}_{re}^{n , m} \cdot {C}_{i}^{n , m} [ t ]}{{V}_{e} \cdot {N}_{A}}$$

The amount of free ligand present in endosomes may also be decreased by the recycling of free ligand which occurs at the rate (kₓ), as represented by:

$$\frac{d {L}_{i}^{n , m}}{d t} = - {k}_{x}^{n , m} \cdot {L}_{i}^{n , m} [ t ]$$

Summing yields

$$\frac{d {L}_{i}^{n , m}}{d t} = \frac{- {k}_{fe}^{n , m} \cdot {L}_{i}^{n , m} [ t ] \cdot {R}_{i}^{n , m} [ t ] + {k}_{re}^{n , m} \cdot {C}_{i}^{n , m} [ t ]}{{V}_{e} \cdot {N}_{A}} - {k}_{x}^{n , m} \cdot {L}_{i}^{n , m} [ t ] \qquad$$

The amount of degraded ligand, L_{d}, may be determined solely by the number of internalized receptor ligand complexes and the degradation rate constant, Kₕ, as represented by:

$$\frac{d {L}_{d}^{n , m}}{d t} = - {k}_{h}^{n , m} \cdot {C}_{i}^{n , m} [ t ] \qquad$$

The amount of free ligand may be decreased by the association of free ligand and receptor on the cell surface, which occurs with the association rate constant (k_{f}), and increased by dissociation of receptor-ligand complexes on the cell surface, which occurs with a dissociation rate constant (kᵣ), as represented by:

$$\frac{d {L}^{n}}{d t} = - {k}_{f}^{n , m} \cdot {L}^{n} [ t ] \cdot {R}_{S}^{n , m} [ t ] \qquad \frac{d {L}^{n}}{d t} = {k}_{r}^{n , m} \cdot {C}_{S}^{n , m} [ t ]$$

The amount of free ligand is also increased by the recycling of ligands in endosomes, which occurs at the rate of kₓ and is multiplied by the endosomal volume (Vₑ) and Avogadro's number (N_{A}), as represented by:

$$\frac{d {L}^{n}}{d t} = {k}_{x}^{n , m} \cdot {L}_{i}^{n} [ t ] \cdot {V}_{e} \cdot {N}_{A}$$

The amount of free ligand may also be increased by the synthesis of free ligand by one or more cell types which may occur in response to receptor-ligand surface complexes for a variety of different receptor types. For instance, the presence of IL-2 receptor-ligand surface complexes can cause NK cells to produce additional IL-2, but may also cause them to produce additional IL-12 or other cytokines. For a given cell type and receptor-ligand complex, the rate of synthesis in response to binding is k_{b}^{n1,n2} where n1 is ligand produced and n2 is the ligand bound, as represented by:

$$\frac{d {L}^{n}}{d t} = {C}_{s}^{n , m} [ t ] \cdot {\int }_{{n}_{2}} {k}_{b}^{{n}_{1} , {n}_{2} , m} d {n}_{2}$$

When summing these equations, they may be multiplied by the cell density Y and divided by Avogadro's number (N_{A}) to capture the fact that the processes are occurring on multiple cells, as represented by:

$$\begin{matrix}\frac{d {L}^{n}}{d t} = ( \begin{matrix}- {k}_{f}^{n , m} \cdot {L}^{n} [ t ] \cdot {R}_{S}^{n , m} [ t ] + {k}_{r}^{n , m} \cdot {C}_{S}^{n , m} [ t ] + \\ {k}_{x}^{n , m} \cdot {L}_{i}^{n , m} [ t ] \cdot {V}_{e} \cdot {N}_{A} + {C}_{s}^{n , m} [ t ] \cdot {\int }_{{n}_{2}} {k}_{b}^{{n}_{1} , {n}_{2} , m} d {n}_{2}\end{matrix} ) & \end{matrix} \cdot \frac{{Y}^{m} [ t ]}{{N}_{A}}$$

These equations may be appropriately modified for ligands which are not free in solution, but rather are present on the surface of diseased cells, or that experience multivalent binding.

The above set of equations is for one specific type of receptor-ligand complex and one specific type of cell. The superscript “n” associated with each parameter allows us to run these equations in parallel for multiple specific types of receptor-ligand complexes, and the superscript “m” allows us to run these equations in parallel for multiple specific types of immune cells. The amount of free ligand (Lⁿ) does not have a superscript “m” because multiple cell types must compete for the same pool of free ligand. For instance, if we wish to examine three specific receptors (IL-2R, NKG2D, and KIR2DL1), then each would be assigned a number (1, 2, and 3 respectively) so that R¹ would represent the number of IL-2 receptors, R² would represent the number of NKG2D receptors, and R³ would represent that number of KIR2DL1 receptors. The three sets of equations would then be solved to yield the number of IL-2/IL-2R receptor ligand complexes (C¹), the number of UL16BP or MICA/NKG2D receptor-ligand complexes (C²), and the number of KIR2DL1/HLA-C2(N77/K80)-Cw4 receptor-ligand complexes (C³).

In one specific embodiment, once the measurable parameters are measured or otherwise determined (e.g., from literature), the mathematical model can be solved to determine the number of receptor-ligand complexes for each activating and inhibitory receptor. In one specific implementation, the set of differential equations may be solved using a program, such as MATLAB.

In one aspect of the invention, the computational system that models the dynamics of receptor-ligand binding and trafficking may take as input one or more parameters that play a role in the processes and equations described above: a number of immune cells of a specific type, a number of diseased cells, a number of receptors per cell for a specific type of receptor on a specific type of cell, a binding affinity of receptors, a number of ligands per diseased cell, a concentration of soluble ligands in solution, a number of therapeutic antibodies per diseased cell, a concentration of therapeutic in solution, an association rate constant, an internalization rate constant, a dissociation rate constant, an induced receptor synthesis rate, an induced ligand synthesis rate, a constitutive rate of receptor internalization, a constitutive rate of receptor biosynthesis, an association rate of receptor and ligand in endosomes, a dissociation rate of receptor-ligand complexes in endosomes, a rate of lysosomal degradation of receptor-ligand complexes, and a rate of recycling of ligand.

In one aspect of the invention, one or more of the parameters described above may be measured specifically for an individual patient. This enables the measured parameters to be utilized with the model for each patient and disease. In one embodiment, parameter measurement may be made from blood or biopsy samples.

In one aspect of the invention, specific parameters are measured from patient samples. In one embodiment, flow cytometry is used to measure one or more of the following: the number of immune cells of a specific type, a number of diseased cells, a number of receptors per cell for a specific type of receptor on a specific type of cell, a number of ligands per diseased cell, or other parameters in the model. In one embodiment, surface plasmon resonance is used to measure the binding affinity of receptors, or other parameters in the model. In one embodiment, immunohistochemistry is used to measure the number of ligands per diseased cell or other parameters in the model. In one embodiment, enzyme-linked immunosorbent assay (ELISA) is used to measure a concentration of soluble ligands in solution, a concentration of therapeutic in solution, or other parameters in the model. In one embodiment, quantitative imaging is used to measure the number of ligands per diseased cell, or other parameters in the model. In one embodiment, HLA tissue typing is used to analyze the ligands on diseased cells, or to determine other parameters in the model. More details on the measurement techniques for each parameter can be found in Appendix A below.

In one aspect of the invention, measurable parameters are determined indirectly using genetic polymorphisms or measuring gene expression levels. In one embodiment, polymorphisms in the Fc receptor are measured instead of determining the binding affinity directly. In another embodiment, polymorphisms in the CTLA4 receptor are used to determine one or more parameters in the model. In one embodiment, polymorphisms in the IL-2 receptor are used to determine one or more parameters in the model. In one embodiment, mRNA expression levels in tumor samples are used to determine the type or quantity of ligands or receptors expressed by the malignant cells. In another specific implementation, one or more parameters can be determined indirectly by assessing an individual patient's genetic polymorphisms and then assigning parameter values that are correlated with these polymorphisms. For instance, the FcγRIIIA receptor with a −158V polymorphism has a higher binding affinity for Rituximab than with a −158F polymorphism, so the binding affinity parameter for an individual could be determined by assessing which polymorphism the individual has.

In one aspect of the invention, specific receptor types used in the model include receptors known to be present on NK cells, CTLs, and/or Tregs. In one embodiment, the balance of activating and inhibitory receptors on NK cells is included in the model. In one embodiment, the receptors include one or more of the following: T cell receptor (TCR), CTLA-4, GITR, histamine receptor (H2R), OX40, CD28, TSLPR, IL-7R, IL-4R, IL-13R, IFN-betaR, NKG2D/CD314, CD16, NKp30/CD337, NKp44, NKp46/CD335, NKp80, KIR2DS1-2, KIR2DS3-6, KIR3DS1, CD32c, KIR2DL4/CD158d, NKG2C/CD94/CD159c, 2B4/CD244, CD2, CRACC/CD319, NTB-A, DNAM-1/CD226, CD7, CD59, BY55/CD160, CD44, IL2-Rα,β,γ/CD25,CD122,CD132, IL-12R/CD212, IL-15R, IFNgR, Type 1 IFN-R, or IFNAR1+IFNAR-2, LFA-1 (αLβ2, CD11a/18), MAC-1 (αMβ2, CD11b/18), CD11c/18, VLA-4 (α4β1, CD49d/29), VLA-5 (α5β1, CD49e/29), KIR2DL1/CD158a, KIR2DL2/CD158b1, KIR2DL3/CD158b2, KIR3DL1/CD158e1, KIR3DL2, NKG2A/CD159a, ILT-2/LIR-1/CD85j, IL-6R, IL-12R, VIPR, LeptingR, PGR, IL-10R/CDw210, TNFalphaR, TGFBR-1, or TGFBR-2, KLRG1, NKR-P1/CD161, Siglec-7/CD328, Siglec-9/CD329, IRp60/CD300a.

In one aspect of the invention, a sensitivity analysis is conducted to determine the relative impact of changes in one or more measurable parameters on the number of receptor-ligand complexes and the development of a cytotoxic response. Some parameters may have a relatively minor effect on the number of receptor ligand complexes and identifying those parameters can reduce the number of necessary measurements in order to reduce the time and expense of determining the extent to which a patient will respond to a given therapeutic regimen. Alternately, some parameters may be found to have a predominant effect, in which case only this smaller subset of parameters needs to be measured.

In one aspect of the invention, data from multiple patients is analyzed in order to determine the range over which various parameters and other factors vary in different patients. Parameters which are the same (or only vary slightly) across all patients can be set to constants in the model and need not be measured. Only those parameters that do vary from patient to patient may need to be measured, and only those patients whose variation is determined to be significant enough to influence the development of a cytotoxic reaction. In one embodiment, this method may be used to reduce a comprehensive measurement down to a relatively small set of “biomarkers” for predicting response.

In one aspect of the invention, patient measurements are accumulated in a database to capture the range of immunological variation among patients, so that ultimately, before a therapy enters human clinical trials, a computational system can be utilized to determine characteristics that can identify subpopulations of likely responders.

In one aspect of the invention, the model may take as input information about the extent to which receptor-ligand complexes are present on the surface of cytotoxic immune system cells before, during, and/or after the administration of a therapeutic regimen for more than one receptor type. The information is then used for various means. In one embodiment, the information is used to for determining the extent to which a patient will respond to a therapeutic regimen. In one embodiment, the information is used for identifying measurable characteristics (biomarkers) that can distinguish subpopulations of patients who differ in the extent of their response to a therapeutic regimen. The information on the extent to which receptor-ligand complexes are present may have been obtained through direct measurement, calculation or other means, and may have been determined using one or more of the methods described in previous claims or using other methods.

In one aspect of the invention, the model may use a numerical weight for each receptor type. In one embodiment, activating receptors are given positive weights and inhibitory receptors are given negative weights. In one embodiment, the weights represent the relative impact of any given receptor type on whether or not a patient develops a cytotoxic reaction. In one embodiment, this system is designed to re-create the processes that a cytotoxic immune cell uses to assess the balance of activating and inhibitory signaling and determine whether or not to develop a cytotoxic reaction. In another aspect of the invention, the relationship between the number of receptor-ligand complexes for each activating and inhibitory receptor and the cytotoxic activation of the immune cell is determined. In one specific implementation, the model utilizes a numerical weight for each specific type of ligand-receptor complex, with positive weights assigned to activating receptors and negative weights assigned to inhibitory receptors. The system multiplies each weight by the number of complexes present for corresponding type of ligand-receptor complex, then sums these products over all the specific types of receptor ligand complexes, and compares the resulting sum to a numerical activation threshold. The weights and thresholds may be determined by fitting experimental data. The threshold is believed to vary from individual to individual.

Continuing the example from the previous section, which describes three specific types of receptor-ligand complexes (C¹, C², and C³), each may have an (W¹, W², and W³), and activation would occur under the following condition:

if (W¹·C¹+W²·C²+W³·C³)≧threshold

In one aspect of the invention, either the numerical weights or the numerical threshold or both may be determined using measurements from one or more patients. In one specific embodiment, the weights and/or threshold can be determined specifically for an individual patient from measurements made on that patient. In another embodiment, data from multiple patients is used to assemble an aggregate set of weights and thresholds, either for all patients or for particular subpopulations of patients.

In one aspect of the invention, the computational system is extended to also model the intracellular signaling that results from receptor-ligand complexes. In one embodiment, this signaling includes the recruitment of kinases and phosphatases by receptors, and the subsequent signaling events. In one embodiment, subsequent signaling events are modeled using rate equations. In one embodiment, the downstream signaling of the IL-2 receptor is modeled including activation of the Jak2/STATS signaling pathways and activation of PI3 Kinase/Akt pathways. In one embodiment, the downstream signaling feeds back into model of receptor-ligand binding through the induced receptor synthesis rate, the induced ligand synthesis rate, and/or the number of cells. In one specific embodiment, downstream signaling can be modeled using rate equations, similarly to the way the kinase cascade is measured. In one specific embodiment, modeling of the intracellular signaling pathways that result from receptor binding includes an assessment of the binding of activating and inhibitory receptors on natural killer cells that activate a variety of known pathways.

In one aspect of the invention, the computational system is extended to include pharmacokinetic/pharmacodynamic information. In one embodiment, a pharmacokinetic/pharmacodynamic model is used to determine information about the extent to which a therapeutic or ligand is present at the site of disease, based on serum measurements or dosage information. In one embodiment, a model of the pharmacokinetics of IL-2 is used to determine the extent to which IL-2 is present.

In one aspect of the invention, the diseased cells may be cancer cells. In one embodiment, these may be malignant cells of renal cell carcinoma, melanoma, lymphoma, or any other type of cancer or malignancy.

In one aspect of the invention, the therapeutic regimen includes a combination of more than one therapy. In one embodiment, one of the therapies is an antibody and another is a cytokine. In one embodiment, one of the therapies is rituximab, herceptin, and/or erbitux and the other therapy is IL-2.

In one aspect of the invention, the therapeutic regiment includes one or more therapies that have a direct or indirect impact on the immune system. In one embodiment, the therapeutic regimen includes one or more of the following: interleukin-2, interleukin-15, interleukin-12, interleukin-18, anti-CD25, anti-CTLA4, anti-GITR, anti-CD28, rituximab, trastuzumab, cetuximab, anti-KIR, anti-NKG2D, anti-MICA, Ontak, anti-TGFbeta, zinc, anti-integrin, histone deacetylase inhibitor, vaccine, cell-based therapy, any antibody designed to produce the antibody-dependent cellular cytotoxicity (ADCC) response, or for any of the receptors mentioned herein for which a therapy is designed to act as a ligand, agonist, antagonist, or to deplete ligand.

In one aspect of the invention, the parameters or other factors are measured at multiple time points to determine if or how they vary over time. In one embodiment, trends over time are extrapolated forward to predict the development of a cytotoxic response. The resulting system provides an individualized, time sensitive assessment of when an individual will initiate a cytotoxic response, meeting a long felt but unsolved need:

In one aspect of the invention, an interface may enable a user to optimize a therapeutic regimen for a particular patient or subpopulation of patients by varying input parameters and determining how changes in those input parameters would affect the development of a cytotoxic response.

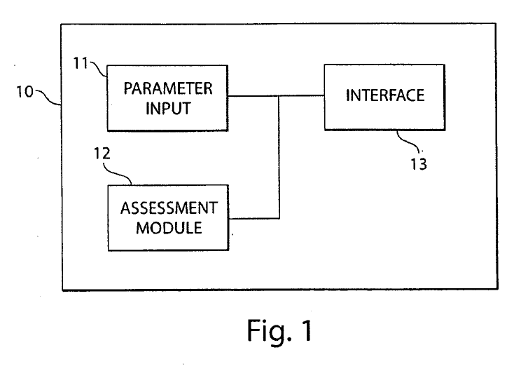

FIG. 1 shows a schematic block diagram of a therapeutic regimen assessment system 10 that incorporates aspects of the invention. Portions of the system 10 may be implemented as part of a computer system, which may include one or more general purpose, programmed computers, a network of computers, one or more special-purpose data processing devices, such as an ASIC, FPGA, etc., and/or other components, e.g., memory devices (optical, magnetic, and/or other volatile or non-volatile memories), communication devices (devices for supporting wired and/or wireless communication within a network or otherwise), one or more software modules, user input/output devices (touch screens, displays, keyboards, a user mouse or other pointing device, a printer, etc.) and other components needed for performing input/output and other functions.

The system 10 in this embodiment includes a parameter input 11, an assessment module 12 and an interface 13. (Other components will likely be included with the system 10, such as memory devices, communication devices, etc., as mentioned above, but are not shown in FIG. 1 for clarity). In this embodiment, the system 10 is implemented on a general purpose, programmed computer. The parameter input 11 may include suitable devices (whether hardware, software or other) for receiving one or more measurable parameters. For example, the parameter input 11 may include a memory (such as a non-volatile disk drive) that stores measurable parameters that are provided to the system 10 via the interface 13 (which may include communication devices, a keyboard, etc.). Alternately, or in addition, the parameter input 11 may include a diagnostic device suitable for running one or more analyses on a patient sample (e.g., a blood sample) and generating a value for one or more measurable parameters. In another embodiment, the parameter input 11 may operate in conjunction with the assessment module 12, e.g., during a sensitivity analysis, to vary one or more measurable parameters in an attempt to identify which parameter(s) have a largest affect on patient immune response when employing a therapeutic regimen. Measurable parameters may be varied in a random or systematic way (e.g., modified in an iterative fashion so as to maximize, or minimize, an output value that represents immune system response).

The assessment module 12 in this illustrative embodiment includes one or more software modules that operate on the computer system to perform the functions described above, including modeling one or more characteristics of the patient immune system (implementing the model described in detail above), receiving input measurable parameters, and assessing how a therapy affects patient immune system response based on the model and the measurable parameters. The assessment module 12 may produce any suitable output to convey how the therapeutic regimen is expected to affect immune system function. For example, the assessment module 12 may output a set of quantitative values representing one or more aspects of immune system response, e.g., a number of cells expected to develop a cytotoxic response, a likelihood of a cytotoxic response occurring, a number of target disease cells that would be destroyed or otherwise neutralized, and so on. In another embodiment, the assessment module 12 may output an easily interpreted value indicative of how the therapeutic regimen is expected to affect the patient's immune system response, such as a percentage likelihood of disease eradication, a text-based indication of the therapeutic regimen's affect (e.g., “poor,” “good,” or “excellent”), a score on a scale that is then correlated with patient response or prognosis, and so on. The assessment module 12 may output a recommendation for an alternate therapeutic regimen, or an effectiveness ranking of two or more regimens, etc. In another embodiment, the assessment module 12 may output information about parameters that have the greatest impact on therapy response in a particular patient and/or for a particular therapy, such as a ranked list of parameters, a range of variation in parameters that will produce a certain outcome, etc. In another embodiment, the assessment module 12 may output a plot where the X axis is dose of a therapy and the Y axis is likelihood of response, or where the Y axis represents an activation level which is compared to a threshold above which activation occurs and below which it does not.

The interface 13 may include any suitable components (hardware, software or other) to receive input from a user, provide output to a user and/or obtain information from one or more sources. For example, the interface 13 may include a keyboard, user pointing device, graphical user interface, touch screen, a wired or wireless communication device (e.g., to receive information via a Bluetooth or other wireless device operated by a user), a speaker, a visual display, and so on. The interface 13 may include a wired or wireless LAN device (such as an Ethernet device) and/or any other device to enable the system 10 to communicate with other devices (e.g., over the Internet or any other suitable network). Such communication ability may permit the interface 13 to retrieve measurable parameter data that may be stored at a remote device, found in published literature, etc. This data may be requested, and used, by the assessment module 12.

In one specific example, the parameter input 11 might receive parameters measured from natural killer cells and regulatory T cells isolated from one or more blood samples of a patient that has melanoma or renal cell carcinoma. These values might include the number of IL-2 receptors on the surface of natural killer cells and their binding affinity, the number of IL-2 receptors on regulatory T cells and their binding affinity, and the number of cells present of each type. These parameters might have been measured using flow cytometry and surface plasmon resonance assays, and the data stored in a spreadsheet or other file which forms the input to the system, e.g., is received by the parameter input 11.

Continuing the example, the assessment module 12 might comprise a personal computer running MATLAB or a similar program for solving a system of differential equations. The system of differential equations (e.g., defining a mathematical model or at least a portion of such a model like that described above) might include a set of equations designed to model the receptor-ligand binding and trafficking dynamics for the IL-2 receptor on natural killer cells and a second set of equations designed to model the receptor-ligand binding and trafficking dynamics for the IL-2 receptor on regulatory T cells. The parameter input 11 may provide a set of initial conditions for the differential equations (such as the measured parameters described above) which are then solved first based solely on the measured values and second based on adjusting the variables in the differential equations to reflect a concentration of IL-2 that can be feasibly achieved in the tumor microenvironment by administration of therapeutic IL-2, given the pharmacokinetics of IL-2 and the characteristics of a particular patient. Such adjustments may be made in an automated way by the assessment module 12, and/or using input from a user received via the parameter input 11. The equations may then be solved to determine whether or not a cytotoxic reaction will occur.

Continuing the example, the output module 13 might display for the given patient a curve which plots a set of values, where the X axis is the dose of therapeutic IL-2 given to a patient and the Y axis is the likelihood of a response. The Y axis could also be an activation level which could then be compared to a threshold above which a cytotoxic reaction occurs and below which it does not.

Aspects, including embodiments described above, can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention (at least with respect to the assessment module 12) comprises at least one computer-readable medium (e.g., a computer memory, a floppy disk, a compact disk, a tape, etc.) encoded with a computer program (i.e., a plurality of instructions), which, when executed on a processor, performs the above-discussed functions of embodiments in accordance with aspects of the present invention. The computer-readable medium can be transportable such that the program stored thereon can be loaded onto any computer environment resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention. It should be appreciated that in accordance with several embodiments of the present invention wherein processes are implemented in a computer readable medium, the computer implemented processes may, during the course of their execution, receive input manually (e.g., from a user).

While aspects of the invention has been described with reference to various illustrative embodiments, the invention is not limited to the embodiments described. Thus, it is evident that many alternatives, modifications, and variations of the embodiments described will be apparent to those skilled in the art. Accordingly, embodiments of the invention as set forth herein are intended to be illustrative, not limiting. Various changes may be made without departing from the invention.

### APPENDIX A

### Example Protocol

Measurements from NK cells isolated from whole blood: We will isolate NK cells from blood and then determine the phenotypes and expression levels of activating and inhibitory receptors including KIR receptors, NKG2 receptors, Fc receptors, and cytokine receptors. We will determine phenotypes and quantify expression levels either directly using flow cytometry or indirectly by examining mRNA levels. We will also determine the binding affinities of these receptors either directly (using a surface plasmon resonance instrument such as BiaCore) or indirectly (by using qPCR or other genetic means to examining polymorphisms correlated with differences in binding affinity). We may also conduct assays of receptor-ligand trafficking dynamics and ADCC assays
Measurements from serum: We will measure the concentrations of various cytokines and other ligands to NK cell receptors based on ELISA assays including multiplexed ELISA assays such as those produced by Luminex or ThermoFisher/Pierce Searchlight
Measurements from tumor tissue: We will analyze tumor tissue to determine the phenotypes and expression levels of human leukocyte antigens (HLAs) and carbonic anhydrase 9 (CA-IX). We will make these measurements using flow cytometry, immunohistochemistry, and/or indirectly by examining mRNA levels. We may also determine the binding affinities of these ligands either directly (using a surface plasmon resonance instrument such as BiaCore) or indirectly (by using qPCR or other genetic means to examining polymorphisms correlated with differences in binding affinity).
Genetic Assays: We may also perform genetic assays to identify new polymorphisms that may be correlated with any of the measurements described above.

1. A method for determining an extent to which a patient will respond to a therapeutic regimen, the method comprising:
providing a set of values for measurable parameters that relate to one or more characteristics of the patient's immune system; and
assessing how a therapeutic regimen will impact functioning of the patient's immune system based on the set of values and receptor-ligand binding and trafficking characteristics of the patient's immune system.

2. The method of claim 1, wherein the step of providing a set of values comprises:
measuring a set of values for parameters that represent one or more characteristics of the patient's immune system.

3. The method of claim 1, wherein the step of assessing comprises:
generating a set of quantitative values that represent how a therapeutic regimen will impact functioning of the patient's immune system based on the set of values and a model of the receptor-ligand binding and trafficking characteristics of the patient's immune system.

4. The method of claim 1, further comprising:
identifying the functioning of the immune system as being more sensitive to variations in one measurable parameter as compared to another measurable parameter.

5. The method of claim 1, wherein the step of providing a set of values comprises:
providing a first set of values for the one or more measurable parameters for a first group of patients; and
providing a second set of values different from the first set of values for the one or more measurable parameters for a second group of patients;
the step of assessing comprises:
assessing how a therapeutic regimen will impact functioning of the immune system for the first group of patients based on the first set of values and receptor-ligand binding and trafficking characteristics of the patient's immune system; and
assessing how a therapeutic regimen will impact functioning of the immune system for the second group of patients based on the second set of values and receptor-ligand binding and trafficking characteristics of the patient's immune system;
the method further comprising:
comparing the affect of the therapeutic regimen on the first group of patients to the affect of the therapeutic regimen on the second group of patients; and
identifying the one or more measurable parameters as representing parameters that distinguish groups of patients as having differing immune system responses to the therapeutic regimen.

6. The method of claim 1, wherein the step of assessing includes determining an extent to which administration of the therapeutic regimen will cause a patient's immune system to develop a cytotoxic response to diseased cells, or to halt a cytotoxic response to healthy cells.

7. The method of claim 6, wherein the step of determining includes an analysis of a number of receptor-ligand complexes present on surfaces of cytotoxic immune system cells before, during, and/or after the administration of the therapeutic regimen, for one or more specific receptor types.

8. The method of claim 6, wherein the step of determining includes an analysis of parameters that provide information about or influence the number of receptor-ligand complexes present on the surface of cytotoxic immune system cells before, during, and/or after the administration of a therapeutic regimen, for one or more specific receptor types.

9. (canceled)

10. The method of claim 9, wherein the computational system models dynamics of receptor-ligand binding and trafficking for one or more specific receptor types on cytotoxic immune system cells.

11-19. (canceled)

20. The method of claim 1, wherein the receptor-ligand binding and trafficking characteristics used in the assessing step relate to one or more of the following receptor types: T cell receptor (TCR), CTLA-4, GITR, histamine receptor (H2R), OX40, CD28, TSLPR, IL-7R, IL-4R, IL-13R, IFN-betaR, NKG2D/CD314, CD16, NKp30/CD337, NKp44, NKp46/CD335, NKp80, KIR2DS1-2, KIR2DS3-6, KIR3DS1, CD32c, KIR2DL4/CD158d, NKG2C/CD94/CD159c, 2B4/CD244, CD2, CRACC/CD319, NTB-A, DNAM-1/CD226, CD7, CD59, BY55/CD160, CD44, IL2-Rα,β,γ/CD25,CD122,CD132, IL-12R/CD212, IL-15R, IFNgR, Type 1 IFN-R, or IFNAR1+IFNAR-2, LFA-1 (αLβ2, CD11a/18), MAC-1 (αMβ2, CD11b/18), CD11c/18, VLA-4 (α4β1, CD49d/29), VLA-5 (α5β1, CD49e/29), KIR2DL1/CD158a, KIR2DL2/CD158b1, KIR2DL3/CD158b2, KIR3DL1/CD158e1, KIR3DL2, NKG2A/CD159a, ILT-2/LIR-1/CD85j, IL-6R, IL-12R, VIPR, LeptingR, PGR, IL-10R/CDw210, TNFalphaR, TGFBR-1, or TGFBR-2, KLRG1, NKR-P1/CD161, Siglec-7/CD328, Siglec-9/CD329, IRp60/CD300a.

21-33. (canceled)

34. A system for determining an extent to which a patient will respond to a therapeutic regimen, the system comprising:
a parameter input that receives a set of values for measurable parameters that relate to one or more characteristics of the patient's immune system; and
an immune system response assessment module that assesses how a therapeutic regimen will impact functioning of the patient's immune system based on the set of values and receptor-ligand binding and trafficking characteristics of the patient's immune system.

35. The system of claim 34, wherein the set of values includes a set of values for parameters that represent one or more characteristics of the patient's immune system that are determined based on actual measurement of physical features of the patient.

36. The system of claim 34, wherein the immune system response assessment module generates a set of quantitative values that represent how a therapeutic regimen will impact functioning of the patient's immune system.

37. The system of claim 34, wherein the immune system response assessment module is arranged to identify the functioning of the patient's immune system as being more sensitive to variations in one measurable parameter as compared to another measurable parameter.

38. The system of claim 34, wherein the parameter input receives a first set of values for the one or more measurable parameters for a first group of patients, and a second set of values different from the first set of values for the one or more measurable parameters for a second group of patients; and
the immune system response assessment module is arranged to assess how a therapeutic regimen will impact functioning of the immune system for the first group and second group of patients based on the first and second sets of values, respectively, and receptor-ligand binding and trafficking characteristics of the patient's immune system, compare the affect of the therapeutic regimen on the first group of patients to the affect of the therapeutic regimen on the second group of patients, and identify the one or more measurable parameters as representing parameters that distinguish the first and second groups of patients as having differing immune system responses to the therapeutic regimen.

39. The system of claim 34, wherein the immune system response assessment module is arranged to determine an extent to which administration of the therapeutic regimen will cause a patient's immune system to develop a cytotoxic response to diseased cells, or to halt a cytotoxic response to healthy cells.

40. The system of claim 39, wherein the immune system response assessment module is arranged to analyze of a number of receptor-ligand complexes present on surfaces of cytotoxic immune system cells before, during, and/or after the administration of the therapeutic regimen, for one or more specific receptor types.

41. The system of claim 39, wherein the immune system response assessment module is arranged to analyze parameters that provide information about or influence the number of receptor-ligand complexes present on the surface of cytotoxic immune system cells before, during, and/or after the administration of a therapeutic regimen, for one or more specific receptor types.

42. (canceled)

43. The system of claim 42, wherein the mathematical model includes dynamics of receptor-ligand binding and trafficking for one or more specific receptor types on cytotoxic immune system cells.

44-45. (canceled)

46. The system of claim 45, wherein the cytotoxic immune system cells include natural killer (NK) cells and/or cytotoxic T lymphocytes (CD8⁺) and the cells that are not cytotoxic immune system cells include regulatory T cells (CD4⁺CD25⁺foxp3) and/or diseased cells.

47-66. (canceled)
